(19) United States
(12) Patent Application Publication
(10) Pub. No.: US 2001/0037208 A1
(43) Pub. Date: Nov. 1, 2001

(54) System and method for collection, compilation, and dissemination of research disclosures

(75) Inventor: Jeffrey Morris Cogen, Flemington, NJ (US)

Correspondence Address: Robert P. Simpson, Esq., Simpson, Simpson & Snyder, L.L.P., 5555 Main Street, Williamsville, NY, 14221-5406, US

(73) Assignee: IP.com, Inc., West Henrietta, NY (US)

(21) Appl. No.: 09/809,880

(22) Filed: Mar. 16, 2001

Related U.S. Application Data
(60) Provisional application No. 60/189,782, filed on Mar. 16, 2000.

(51) Int. Cl. G06F 17/60

(52) U.S. Cl. 705/1

(57) ABSTRACT

A method of publishing third-party non-patent-pending invention disclosures on a global information network site. The invention disclosures are published and made available to the public on a searchable database nearly simultaneously with their receipt. Thus, within a few moments of the drafting of the disclosure, it will be available to serve as a defense against the patenting of the invention that is described in the disclosure. This method precludes the filing of a patent application by a third party between the time that a disclosure is submitted for publication the time it is actually published, as is possible with all currently available methods.

### RELATED APPLICATION

This patent application claims the benefit of U.S. Provisional Application Ser. No. 60/189,782, filed Mar. 16, 2000.

### FIELD OF THE INVENTION

This invention relates generally to a system and method for collection, compilation and dissemination of research disclosures.

### BACKGROUND OF THE INVENTION

In most industrial countries, a publication of an invention anywhere in the world serves to bar any person from obtaining a valid patent on that same invention after such publication.

In the United States, this statutory bar to obtaining a valid patent does not become absolute until a year after such publication. That is, a person may file within one year in the U.S. from the date of any such publication, but must prove that their invention was made prior to the date of the publication.

Accordingly, many corporations publish on the subject matter of inventions which they might use in the future but for which patent protection is not sought. In this way, they preserve the right to use their inventions against any third parties who may later come up with the invention and try to patent it. Thus the publication of a research disclosure serves in this way as a defensive publication. To provide for convenient publication of inventions throughout the world, various publications exist or have existed in the past.

The journal Research Disclosure (published by Kenneth Mason Publications, Ltd, Dudley House, 12 North Street, Emsworth, Hampshire PO10 7DQ, England) has existed since 1960 to serve the above-mentioned need. Instructions for inventors wishing to publish a disclosure in the journal Research Disclosure, which are printed in each edition of the journal, state: “Both text and illustrations should be submitted on A4 or 8.5×11 inch paper using a good quality black ribbon typewriter, computer printer, or laser printer to produce the disclosure copy. The type size should be no smaller than 12 pt. A margin of 1 inch (2.5 cm) should be allowed on all four sides. Number pages lightly in pencil as they will be renumbered for publication. Start with a headline, ranged left in upper and lower case. Thereafter paragraphs should be indented. End with ‘Disclosed by . . . your company name, inventor etc.,’ or ‘Disclosed anonymously’ again ranged left in upper and lower case. Keep punctuation, particularly in headlines and artwork, to a minimum.”

On the same page, the instructions state: “This service enables publication to be made worldwide within a maximum of six weeks.” “Copy received in New York by the 20th of each month appears on the 10th of the following month, except where it falls on a weekend or bank holiday.”

At its Internet site (http://www.researchdisclosure.com, date unknown), it is readily apparent that there is no means for submitting or viewing research disclosures electronically. To the contrary, text at the web site reads: “Send the disclosure copy and order details to the New York office only at the address shown below, E-mail and fax copy are not accepted for publication.” As mentioned above, there is a considerable delay, ranging from 18 days to as much as six weeks, or more, between the time that a research disclosure is submitted for publication and the time that it actually is published and is available to the public. This delay can result in failure to achieve the intended goal in the event that a patent application is filed by a third party between the time that a research disclosure is submitted for publication and the time that it actually is published and is available to the public.

In the past, Xerox Corporation has published its own research disclosures. In addition to providing printed copies, it eventually made its research disclosures accessible to the public at its Internet site (http://www.xerox.com/research/xdj/, date unknown). Although the presence on the Internet made it easy for viewers to access their disclosures, Xerox's system is of limited utility due to the fact that only agents of Xerox Corporation were able to publish there; there was no publicly disclosed means for submitting research disclosures via computer; and there is no indication of how quickly the disclosures were posted at the site (electronically published) after being submitted by the agent.

IBM Corporation has in the past published its own research disclosures in a similar fashion to Xerox (http://www.ibm.com/ibm/licensing/ibm_tdb/, date unknown). Their system was also of limited utility for the same reasons listed above for Xerox's system.

It is important to note that electronic publication can provide the intended defensive function. “Electronic transmission of abstracts, articles, or research reports is also a form of publication or public disclosure. Scientists should be aware that many journals and scientific societies often place material on the World Wide Web prior to written publication, creating an increased potential for loss of patent rights.” (From the Harvard Medical School Office of Technology Licensing Internet site at http://www.hms.harvard.edu/otl/patents.html, 1999.)

It is important to emphasize again that a research disclosure publication delay of a single day can make the difference between successfully or unsuccessfully preventing a patent from being obtained by a third party.

With the importance of being able to quickly publish research disclosures to achieve the earliest possible publication date, and the ever-growing need for high worker productivity for corporations to remain competitive, clearly industry needs a more rapid and efficient method and system for collection, compilation, and dissemination of research disclosures.

### SUMMARY OF THE INVENTION

The present invention is intended to aid inventors and their agents in ease and rapidity of publishing their research disclosures. It is also intended to aid inventors, patent attorneys, patent examiners, and other interested parties in searching a multiple entity research disclosure database for prior art. As will become apparent hereinafter, the present invention permits nearly instantaneous publication of research disclosures by multiple individuals, agents of multiple companies, agents of multiple corporations, and agents of multiple organizations.

In particular, the present invention is directed to a system and method for compiling a database of research disclosures from multiple entities (a multiple entity research disclosure database), characterized in that the system and method enable very rapid publication and dissemination of the research disclosures when compared to prior art methods which rely on submission of printed matter, where such prior art methods and systems are subject to significant delay between submission and publication.

Another embodiment of the invention is to provide a system and method for rapid dissemination of research disclosures from multiple entities, characterized in that the system and method enable very rapid dissemination of the research disclosures when compared to prior art methods which rely on publication and mailing of printed matter.

Another embodiment of the invention is to provide for a system and method for rapid searching of research disclosures from multiple entities, characterized in that the system and method enable thorough searching of the research disclosures in a multiple entity research disclosure database, in contrast to the prior art.

Another embodiment of the invention is a system and method for viewing a multiple entity research disclosure database, characterized in that the system and method enable immediate access to research disclosures in the multiple entity research disclosure database as well as access to older research disclosures in the multiple entity research disclosure database.

In another embodiment of the invention, the contents of the electronically-created multiple entity research disclosure database can be periodically printed, published, and distributed in conventional (print) format to satisfy the needs of those who want printed matter for their records, yet the research disclosure achieves the “publicly disclosed” status from the time it is entered into the publicly accessible multiple entity research disclosure database. This includes a system and method for printing a publication-ready version of some or all of the multiple entity research disclosure database.

Another embodiment of the invention is to provide for a system and method for combining two or more of the above embodiments, e.g., for rapid compilation, dissemination, and searching of research disclosures from multiple entities.

Further embodiments and advantages of the present invention will become apparent hereinafter, and by reference to the cited references.

### BRIEF DESCRIPTION OF THE DRAWINGS

FIG. 1 is a flow chart describing the method by which at least one entity submits at least one non-patent-pending invention disclosure to the publisher and the nearly instantaneous publication of the submitted disclosure for viewing by the general public.

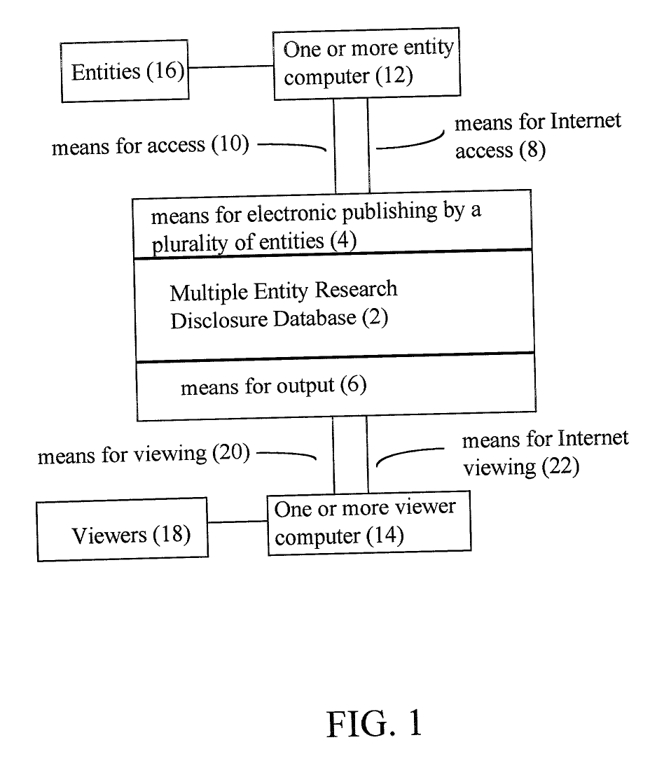

### DETAILED DESCRIPTION OF THE PREFERRED EMBODIMENT

The following terms and acronyms are used throughout the detailed description and the claims:

Global Information Network: A collection of interconnected public and/or private networks that are linked together by a set of standard protocols such as HTTP, to form a global, distributed network. The term “Global Information Network” is also intended to encompass changes and additions to existing standard protocols that may be made in the future. One embodiment of a Global Information Network is known as the “Internet.”

HTTP (Hyper Text Transport Protocol): The standard World Wide Web protocol Used for the exchange of information (such as HTML documents, and web browser requests for such documents) between a browser and a Web server.

HTML (Hyper Text Markup Language): Computer software codes for attaching presentation and linking attributes to informational content within documents. Documents sent to the Web browser contain HTML codes (referred to as “tags”) embedded within the informational content of the document. When the Web document (or HTML document) is subsequently received by a Web browser, the codes are interpreted by the browser and used to parse and display the document. Additionally HTML tags can be used to create links to other Web documents (commonly referred to as “hyperlinks”).

“Non-patent pending” means that a patent application has not been filed for an invention described in an invention disclosure.

Third party: The present invention contemplates that an entity will publish an invention disclosure on a site on a Global Information Network. Third-party, as used herein, is intended to mean any entity other than the entity who owns or otherwise controls the invention disclosure publication web site.

“Catalogued”, as used herein, refers to the process by which an invention disclosure is entered into a publicly available list of disclosure documents that are accessible for viewing. A catalogued document is one whose public accessibility status is documented.

The term “research disclosure” is generally known to those skilled in the art. A research disclosure, which for the purposes of the present invention is the same as an invention disclosure, a disclosure, or a technical disclosure, is a description of an invention, containing text and optionally one or more diagrams, drawings, tables, graphs or figures, and optionally one or more references to prior literature. In particular, research disclosures describe a new and useful:

process; or

machine; or

an article of manufacture; or

a composition of matter; or

new and useful improvements of the above; or

any distinct and new variety of plant which is asexually reproduced; or

any new, original, and ornamental design for an article of manufacture.

The research disclosure document must contain more than about 50 words, as they must provide adequate detail to serve their intended purpose of describing an invention, and must contain less than about 2,200 words.

In the preferred mode, the disclosure will contain more than about 50 words and less than about 1,900 words and will contain less than about 20 references to literature or prior art. They may optionally contain the name of one or more authors, or companies, or they may be published anonymously. Often they do not contain the name of the author's company, if any, nor the name of the author.

Other information can optionally be included, in addition to the text, such as field of the invention, date of invention, one or more diagrams, drawings, tables, graphs or figures, and optionally one or more references to prior literature etc., while still being within the scope of this invention.

Examples of research disclosures can be found in the journal Research Disclosure, published by Kenneth Mason Publications, Ltd, Dudley House, 12 North Street, Emsworth, Hampshire PO10 7DQ, England. Many examples are available in this publication from 1999, pages 1 to 1734, which are incorporated herein by reference.

Additional examples of research disclosures can be found at Xerox's web site (http://www.xerox.com/research/xdj/, date unknown), incorporated herein by reference, and IBM's web site ((http://www.ibm.com/ibm/licensing/ibmtdb/, date unknown), incorporated herein by reference.

A critical element of the present invention is that the system and method allow research disclosures to be submitted (added to the database) by agents of multiple companies, corporations, or organizations, i.e., it is a multiple entity research disclosure database. An entity is defined as a company or corporation and any of its computers, officers, attorneys, agents, or employees. In the case where an individual is submitting a research disclosure on behalf of himself or herself rather than as an agent of a company or corporation, the individual is an entity. In a case where an agent may represent more than one company, corporation, or organization, that agent is acting as multiple entities. For example, an agent (A1) who takes on the responsibility of filing research disclosures for Company A and Company B, is serving as two distinct entities. In the case of two different agents (A1 and A2) submitting research disclosures (R1 and R2, respectively) to the multiple entity research disclosure database on behalf of a single company, agents A1 and A2 are considered to be a single entity as pertains to research disclosures R1 and R2.

A multiple entity research disclosure database is a collection of electronic records containing a plurality of research disclosures, with the proviso that it must contain research disclosures from at least two different entities. Several database structures will be obvious to those skilled in the art. For more information on possible database structures see “Fundamentals of Database Systems,” second edition, by R. Elmasri and S. B. Navathe Addison-Wesley press, NY, 1994, incorporated herein by reference.

By way of example, the database may be a collection of files, each file containing all of the pertinent information for a single research disclosure, such as the title and text of a research disclosure, the date of entry into the database, the inventor name or anonymous designation. Alternatively, the database may be structured such that elements of each disclosure are dispersed among two or more electronic files. For example, one file may contain all of the titles of the various disclosures while another file may contain all of the descriptions of the various disclosures, while a third file may contain all of the inventor names (including anonymous designations).

By way of additional example, the multiple entity research disclosure database may actually be a group of single or multiple entity research disclosure databases. For example, a unique database may be maintained for each entity that submits research disclosures. The critical feature is that all of the data in the multiple entity research disclosure database or group of single or multiple entity research disclosure databases are accessible to perform substantially like a single database containing research disclosures from multiple entities.

The method by which the information is transmitted from the entity computers to the means for electronic publishing by a plurality of entities, and from the means for output to the viewer computers is not critical, as long as it is electronic. In the preferred embodiment the entity computers and viewer computers will communicate via the Internet with the means for electronic publishing by a plurality of entities (means for electronic publishing by a plurality of entities is defined below), and means for output. However, it is also possible that the computers of one or more entities or viewers will communicate with the means for electronic publishing by a plurality of entities, and/or means for output using other electronic communications media. By way of example, this can include a wide area network, a direct telephone connection, satellite communication, cellular telephone communication, email, computer diskette, fax with optical character recognition, or combination of two or more electronic transmission means. In the least preferred embodiment a human being can intervene between electronic transmission of the research disclosure from an entity, and receiving of the electronic research disclosure by means for electronic publishing by a plurality of entities, such as when the research disclosure is submitted by email or diskette file, with said email or diskette file subsequently being transmitted to means for electronic publishing by a plurality of entities, by said human being. The key feature is that the research disclosures from multiple entities can be rapidly submitted and entered into the multiple entity research disclosure database, resulting in rapid publication, since there is no delay waiting for printed research disclosures to be sent and waiting for the subsequent printed publication to issue.

Computers used by the entities and viewers (entity computers and viewer computers) to submit and view research disclosures include any device that enables one to gain access to the Internet or other communication network. Examples include hand held computers, digital cellular telephones, personal communications services (PCS) devices, personal digital assistants, desktop or laptop computers, network servers, and fax machines. Other devices for gaining access to the Internet or other communication network will be apparent to those skilled in the art.

Means for access refers to any communication method by which the entity computer communicates with the means for electronic publishing by a plurality of entities. Means for Internet access refers to the specific case of the Internet as the means for access.

Means for viewing refers to any communication method by which the viewer computer communicates with the means for output. Means for Internet viewing refers to the specific case of the Internet as the means for viewing.

Means for electronic publishing by a plurality of entities represents one or more computer programs configured to process electronic research disclosure information and enter it into the multiple entity research disclosure database. In the preferred embodiment, means for electronic publishing by a plurality of entities is one or more common gateway interface (CGI) scripts running on a network server. The CGI scripts would be invoked when the entity submits a research disclosure via a web page at a web site. Such CGI scripts can be written in many different computer languages, including Perl, C++, Java, and Visual Basic. Examples of CGI scripts using C++ and Perl can be found in “CGI Developer's Guide” by Eric Kim, Sams.net publishing, 1996; incorporated herein by reference, and in “Teach Yourself Perl 5 in 21 Days” by David Till, Sams.net publishing, 1996, incorporated herein by reference. Additional information on C++ can be found in “C++ Unleashed,” by J. Liberty, Sams Publishing, 1999, incorporated herein by reference. Information on Visual Basic can be found in “Mastering Visual Basic 6,” by E. Petroutso, Sybex, 1998, incorporated herein by reference. Information on web programming with Java, CGI, Javascript and HTML can found in “Core Web Programming,” by M. Hall, Prentice Hall PTR, 1998, incorporated herein by reference. Additional information and examples on how to provide input to and invoke CGI scripts from a web page can be found in the abovecited “CGI Developer's Guide” and in “Teach Yourself Web Publishing with HTML 4 in 21 Days,” by L. Lemay, Sams Publishing, 1999, incorporated herein by reference.

In another embodiment, means for electronic publishing could also be a word processor, spreadsheet, email, Adobe Acrobat or other program. For example, if a research disclosure is submitted by an entity as a word processor document attachment via email, and the word processor document is entered into the multiple entity research disclosure database by a human being, then the email program and word processor program comprise the means to effect electronic publishing by a plurality of entities. Many other computer languages and programs sufficient to serve as means for electronic publishing by the publisher for a plurality of entities will be evident to those skilled in the art.

Means for output is one or more computer programs configured to retrieve and transmit electronic research disclosure information from a multiple entity research disclosure database. In the preferred embodiment, means for output is one or more common gateway interface (CGI) scripts running on a network server. The CGI scripts would be invoked, for example, when the viewer requests a research disclosure via a web page at a web site. (See above references for information on CGI scripts, Perl, C++, Java, HTML, and Visual Basic.) In another embodiment, means for output could also be a word processor, spreadsheet, email, Adobe Acrobat, or other program. For example, if a viewer requests a research disclosure via email, the disclosure could be transferred to said viewer as a word processor document attachment via email, particularly if the database record for that research disclosure is in the form of a word processor document. As with means for electronic publishing by a plurality of entities, intervention by a human being is within the scope of the invention, though less preferred. For example, the viewer may submit an electronic request for a research disclosure via a web page. The request may be electronically transmitted to a human being via the Internet. The human being may then retrieve the electronic research disclosure from the multiple entity research disclosure database and send it, via email, to the viewer. The key feature is that the means for output enables extremely rapid dissemination of research disclosures from a multiple entity research disclosure database.

In yet another embodiment of the invention, the contents of the electronically-created multiple entity research disclosure database can be periodically printed, published, and distributed in conventional (print) format to satisfy the needs of those who request to receive printed matter. This embodiment provides for an extremely efficient method for creating the printed publication, since 1) the research disclosures can be submitted electronically, and 2) the electronic research disclosures enjoy the legal status of “publicly disclosed” from the moment they are entered into the multiple entity research disclosure database, and 3) the printed publication can be generated quickly in an automated fashion from the multiple entity research disclosure database.

Passwords may be utilized at various stages. For example, a password may be required in order to submit a disclosure and/or in order to view disclosures. This would enable the company maintaining the multiple entity research disclosure database to require entities and/or viewers to register and/or to subscribe for the privilege of using the multiple entity research disclosure database. Methods for password protection are described in the above-cited books (“CGI Developer's Guide” and “Teach Yourself Web Publishing with HTML 4 in 21 Days, incorporated herein by reference).

In another embodiment of the invention, a method is employed for digitally time-stamping, fingerprinting, and registering the content of the multiple entity research disclosure database. In this process, certain content of the multiple entity research disclosure database are electronically processed in a manner that allows one to determine whether or not the file has ever been changed, as well as when it was registered. This can be accomplished using procedures that are known, see, for example, http://www.firstuse.com, incorporated herein by reference. For example, at the end of each week, all new research disclosures submitted during that week may be combined into a single text file, and the text file may then be digitally time stamped, fingerprinted, and registered at http://www.firstuse.com. Any party wishing to verify that the file contents have remained unchanged since registration, may verify the registration date and integrity of the file at http://www.firstuse.com. As long as that week's file remains accessible via the means of output, this procedure allows for the same level of reliance as is provided by public disclosure via printed publication.

The system and related components of the invention are illustrated in the accompanying drawing.

### EXAMPLES

The following fictitious examples are intended to help describe the invention, but are not intended to be comprehensive or limiting.

### Comparative Example 1

### Prior Art

An engineer working at XYZ Corporation wishes to publish a research disclosure to protect the right of XYZ Corporation to practice the subject matter of the invention. Wishing to publish a research disclosure on her work in the journal Research Disclosure, she carefully prepares her 800 word research disclosure (with one illustration) according to the instructions provided by the journal Research Disclosure, paying careful attention to such details as margins, font size, and layout.

She finishes the research disclosure on May 22nd at 11:55 AM, and sends it via overnight mail to the publisher, who receives it on May 23rd. It is not published until July 10th, 49 days after she mailed the completed research disclosure.

During the 49 days between completion and publication of the research disclosure, no defensive publication was in place to protect XYZ Corporation's rights to practice the technology described in the research disclosure. A third party could have filed a patent application during this delay period.

### Example 2

### Multiple Entity Research Disclosure Database

The same engineer working at XYZ Corporation (entity 1) wishes to publish a second 800 word research disclosure to protect the right of XYZ Corporation to practice the subject matter of a second invention. This time she will publish the research disclosure in a multiple entity research disclosure database run by ZZZ Corporation. She completes the research disclosure on May 22nd at 11:30:12 AM, and at 11:31:24 AM she visits ZZZ Corporation's web site, via the Internet. At the web site she accesses a web page for submitting research disclosures to the multiple entity research disclosure database. The web page contains form input fields, controls, and elements, such as text-entry fields, select elements, text area controls, password controls, submit buttons, checkbox controls, radio controls, text-area controls, and other form input fields, controls, and elements (for definition and how to implement form input fields, controls, and elements into web pages see above-cited HTML and GGI references) into which the user is instructed to enter the following (in this example, on the actual web page, there would be input boxes to enter the requested information). The user is instructed to click on the “submit” button when all of the information has been entered.

Enter author name, or anonymous in the following box:

Enter company name in the following box (optional):

Enter title of the research disclosure in the following box:

Enter text of research disclosure in the following box:

Enter the location of any images to be included separated by commas:

Please click on the “Submit” button when you are ready to publish the research disclosure. Note that the date and time of publication will automatically be added to the research disclosure during processing.

The engineer copies the text from her word processor file and pastes it into the appropriate boxes on the web page (using the copy and paste functions in Microsoft Windows®), and then clicks on the submit button at 11:36:10 AM, less than six minutes after she finished writing the research disclosure.

The form is then transmitted over the Internet (means of Internet access) to a server running at ZZZ Corporation, where the information entered by the engineer at XYZ Corporation is processed by a CGI script (means for electronic publishing by a plurality of entities) and entered into ZZZ Corporation's multiple entity research disclosure database at 11:36:12 AM, two seconds after the engineer clicked the submit button and six minutes after she finished writing the research disclosure. Once it was entered into the multiple entity research disclosure database at 11:36:12 AM it became fully accessible by viewers via the Internet (means of viewing) who can view published research disclosures at ZZZ Corporation's web site. Thus, six minutes after she finished writing the research disclosure, it was legally published (publicly disclosed) and was serving its intended function, as a bar against a third party obtaining a valid patent covering the technology described in the research disclosure.

For the benefit of those who would like to receive printed matter, ten days later on the first of June, ZZZ Corporation prints, publishes in printed form, and distributes to all subscribers the printed research disclosures submitted during the month of May.

### Example 3

### Multiple Entity Research Disclosure Database

A patent clerk at YYY Corporation (Entity 2) logs on to the Internet, using a computer, to file a research disclosure into a multiple entity research disclosure database located on a server at ZZZ Corporation. After entering all of the pertinent information into a form on a web page generated at ZZZ Corporation's web site, the patent clerk clicks on the submit button at the bottom of the web page and the information entered by the clerk is transmitted via the Internet (means of Internet access), processed by a computer program (means for electronic publishing by a plurality of entities) on ZZZ Corporation's server, and entered into ZZZ Corporation's multiple entity research disclosure database. In this example, the pertinent information submitted by the patent clerk included the following information (the information requested on the form is underlined, and the response submitted by the patent clerk is in quotations; NP means no response was provided by the patent clerk):

Author: “anonymous”

Company Name: “NP”

Research disclosure: “A improved process for making water from hydrogen and oxygen has been invented. If a noble metal catalyst is added to a mixture of hydrogen and oxygen at gas pressures below 0.1 torr, water is formed with reduced chances of explosive release of energy which may be encountered when carrying out the same reaction at higher gas pressures. The noble metal catalyst can be a metal foil, film, or single crystal, or supported on a solid support such as alumina or silica. Possible metals include Palladium, Platinum, Rhodium, Iridium, or Nickel. The temperature can be from 0° C. to 30° C. The pressure is maintained below 0.1 torr by a vacuum pump.”

In this example, no date or time was requested from or entered by the patent clerk because the means for electronic publishing by a plurality of entities will automatically attach a date and time to the database record during processing.

After all of the requested information is entered into the form, the user is instructed to click on the submit button, which transmits the research disclosure via the Internet (Internet access means) to a CGI script for immediate automatic processing (means for electronic publishing by a plurality of entities) at ZZZ Corporation and entered into ZZZ Corporation's multiple entity research disclosure database.

Ten minutes later, a scientist at JJJ Corporation (Entity 3) logs on to the Internet, using a computer, to file an research disclosure into the multiple entity research disclosure database located on ZZZ Corporation's server. After entering all of the pertinent information into a form on a web page generated at ZZZ Corporation's web site, the scientist clicks on the submit button at the bottom of the web page and the information entered by the scientist is transmitted, via the Internet (means of Internet access), processed by a the computer program (means for electronic publishing by a plurality of entities) on ZZZ Corporation's server, and entered into ZZZ Corporation's multiple entity research disclosure database.

### Example 4

### Viewing a Multiple Entity Research Disclosure Database

Two days after the patent clerk from YYY Corporation published his research disclosure as described in example 3, an individual inventor (viewer 1) visits ZZZ Corporation's web site, via the Internet, and conducts a search to see if there is any public disclosure (prior art) pertaining to an invention he is working on related to use of Palladium on alumina at low pressure to make water. After entering appropriate search words into the search field on the web page and clicking on the submit button at the bottom of the web page, the search request is transmitted via the Internet to and processed by a computer program (means for output) on ZZZ Corporation's server, which transmits the titles of all research disclosures in ZZZ Corporation's multiple entity research disclosure database that contain the search words. Each of these titles is hyper-linked such that by clicking on the title the entire research disclosure record is transmitted to viewer 1 via the Internet (means of Internet viewing). He quickly finds the research disclosure that was published by YYY Corporation two days earlier.

Based on the results of this search, the individual inventor decides not to file a patent application in view of the previous closely related public disclosure by YYY Corporation.

What is claimed is:

1. A method of publishing at least one third-party non-patent-pending invention disclosure on a site on a global information network, comprising:
a. receiving said at least one third-party non-patent-pending invention disclosure; and,
b. publishing said at least one third-party non-patent-pending invention disclosure on said site on said global information network.

2. The method of claim 1 further comprising the step of receiving said at least one third-party non-patent-pending invention disclosure electronically.

3. The method of claim 2 further comprising the step of receiving said at least one third-party non-patent-pending invention disclosure in an electronic manner selected from the group consisting of a wide area network, direct telephone connection, satellite communication, cellular telephone communication, email, computer diskette, and facsimile with optical character recognition.

4. The method of claim 1 further comprising the step of publishing said at least one third-party non-patent-pending invention disclosure on said site on said global information network in less than eighteen months from time of said receipt.

5. The method of claim 1 further comprising the step of publishing said at least one third-party non-patent-pending invention disclosure on said site on said global information network in less than nine months from time of said receipt.

6. The method of claim 1 further comprising the step of publishing said at least one third-party non-patent-pending invention disclosure on said site on said global information network in less than one month from time of said receipt.

7. The method of claim 1 further comprising the step of publishing said at least one third-party non-patent-pending invention disclosure on said site on said global information network in less than one week from time of said receipt.

8. The method of claim 1 further comprising the step of publishing said at least one third-party non-patent-pending invention disclosure on said site on said global information network in less than one day from time of said receipt.

9. The method of claim 1 further comprising the step of publishing said at least one third-party non-patent-pending invention disclosure on said site on said global information network nearly contemporaneously with time of said receipt.

10. The method of claim 1 further comprising the step of publishing said at least one third-party non-patent-pending invention disclosure on said site on said global information network contemporaneously with time of said receipt.

11. The method of claim 1 further comprising the step of time stamping said received at least one third-party non-patent-pending invention disclosure to indicate a time of receipt of said disclosure.

12. The method of claim 1 further comprising the step of date stamping said received at least one third-party non-patent-pending invention disclosure to indicate a date of receipt of said disclosure.

13. The method of claim 1 further comprising the step of cataloguing said received at least one third-party non-patent-pending invention disclosure.

14. The method of claim 13 further comprising the step of entering said catalogued at least one third-party non-patent-pending invention disclosure into a publicly accessible searchable database.

15. The method of claim 14 further comprising the step of time stamping said catalogued at least one third-party non-patent-pending invention disclosure to document a time said catalogued at least one third-party non-patent-pending invention disclosure becomes a publicly accessible document.

16. The method of claim 14 further comprising the step of date stamping said catalogued at least one third-party non-patent-pending invention disclosure to document a date said catalogued at least one third-party non-patent-pending invention disclosure becomes a publicly accessible document.

17. The method of claim 1 further comprising the step of publishing said at least one third-party non-patent-pending invention disclosure electronically.

18. The method of claim 1 further comprising the step of making said at least one third-party non-patent-pending invention disclosure available for printing.

19. A method of publishing at least one third-party invention disclosure on a site on a global information network, comprising:
a. receiving said at least one third-party invention disclosure; and,
b. publishing said at least one third-party invention disclosure on said site on said site on said global information network nearly contemporaneously with said receipt of said at least one third-party invention disclosure.

20. The method of claim 19 wherein said at least one third-party invention disclosure is a non-patent-pending invention disclosure.

21. The method of claim 19 further comprising the step of publishing said at least one third-party invention disclosure on said site on said global information network contemporaneously with said receipt.

22. The method of claim 19 further comprising the step of receiving said at least one third-party invention disclosure electronically.

23. The method of claim 22 further comprising the step of receiving said at least one third-party invention disclosure in an electronic manner selected from the group consisting of a wide area network, direct telephone connection, satellite communication, cellular telephone communication, email, computer diskette, facsimile with optical character recognition.

24. The method of claim 19 further comprising the step of time stamping said received at least one third-party invention disclosure to indicate a time of receipt of said disclosure.

25. The method of claim 19 further comprising the step of date stamping said received at least one third-party invention disclosure to indicate a date of receipt of said disclosure.

26. The method of claim 19, further comprising the step of cataloguing said received at least one third-party invention disclosure.

27. The method of claim 26 further comprising the step of entering said catalogued at least one third-party invention disclosure into a publicly accessible searchable database.

28. The method of claim 27 further comprising the step of time stamping said catalogued at least one third-party invention disclosure to document a time said catalogued at least one third-party invention disclosure becomes a publicly accessible document.

29. The method of claim 27 further comprising the step of date stamping said catalogued at least one third-party invention disclosure to document a date said catalogued at least one third-party invention disclosure becomes a publicly accessible document.

30. The method of claim 19 further comprising the step of publishing said at least one third-party invention disclosure electronically.

31. The method of claim 19 further comprising the step of making said at least one third-party invention disclosure available for printing.

32. An apparatus for publishing at least one third-party non-patent-pending invention disclosure over a global information network, comprising:
a) means for receiving said at least one third-party non-patent-pending invention disclosure; and,
b) means for publishing said at least one third-party non-patent-pending invention disclosure.

33. The apparatus recited in claim 32 wherein said means for receiving at least one third-party non-patent-pending invention disclosure over a global information network further comprises a computer connected to said global information network.

34. The apparatus recited in claim 32 wherein said means for publishing at least one third-party non-patent-pending invention disclosure over a global information network further comprises a computer connected to said global information network operatively arranged to publish said at least one third-party non-patent-pending invention disclosure.

35. An apparatus for publishing at least one third-party invention disclosure on a global information network, comprising:
a. means for receiving said at least one third-party invention disclosure; and,
b. means for publishing said at least one third-party invention disclosure on said global information network nearly contemporaneously with said receipt of said at least one third-party invention disclosure.

36. The apparatus recited in claim 34 wherein said means for receiving at least one third-party non-patent-pending invention disclosure over a global information network further comprises a computer connected to said global information network.

37. The apparatus recited in claim 34 wherein said means for publishing at least one third-party non-patent-pending invention disclosure over a global information network further comprises a computer connected to said global information network operatively arranged to publish said at least one third-party non-patent-pending invention disclosure.
